(19) United States
(12) Patent Application Publication
(10) Pub. No.: US 2024/0037409 A1
(43) Pub. Date: Feb. 1, 2024

(54) TRANSFER MODELS USING CONDITIONAL GENERATIVE MODELING

(71) Applicant: Telefonaktiebolaget LM Ericsson (publ), Stockholm (SE)

(72) Inventors: Selim ICKIN, Stocksund (SE); Caner KILINC, Täby (SE); Farnaz MORADI, Stockholm (SE); Alexandros NIKOU, Stockholm (SE); Mats FOLKESSON, Täby (SE)

(21) Appl. No.: 18/022,216

(22) PCT Filed: Aug. 21, 2020
(86) PCT No.: PCT/EP2020/073557

§ 371 Date: Feb. 20, 2023

(51) Int. Cl. G06N 3/096; G06N 3/045

(52) U.S. Cl. CPC G06N 3/096; G06N 3/045

(57) ABSTRACT

A method is provided. The method includes generating a first data by using a first decoder model with a first set of target features, wherein the first decoder model is based on the first source domain. The method includes updating a final set of target features and final data based on the generated first data. The method includes generating a second data by using a second decoder model with a second set of target features, wherein the second data that is generated is conditioned on the first set of target features and wherein the second decoder model is based on the second source domain. The method includes updating the final set of target features and final data based on the generated second data. The method includes training a target-domain model using the final data and the final set of target features.

### TECHNICAL FIELD

Disclosed are embodiments related to transfer models; and, in particular, to transfer models using conditional generative modeling.

### BACKGROUND

Transfer learning may be used in cases where machine learning models are developed to solve one type of problem, and then applied to solve another, similar problem. By using the same set of input features as in the original problem, with some additional features or with some features absent as applied to the new problem, decentralized learning methods such as transfer learning are often the right method in order to transfer the knowledge learned from a source domain to a target domain in the form of a neural network machine learning model. In the ideal case, the input feature set used in both the target and source domains are the same, and a model trained on one group (dataset) performs in the target domain as good as it does in the source domain, without having to exert additional effort for model tuning or other adjustments.

There exists different kinds of approaches to machine learning generally, and specifically to transfer learning, e.g. based on different scenarios. Types of learning include semi-supervised learning (where source and target domains are drawn from the same distribution), multi-view learning (learning from different aspects, e.g. video signal and audio signal), multi-task learning (learning collaboratively from multiple related tasks, with equal attention to each task), and transfer learning (giving attention to a target task). A survey of different transfer learning approaches can be found in “A Comprehensive Survey on Transfer Learning” by Zhuang F. et al., available at arxiv.org/pdf/1911.02685.pdf.

Transfer learning may be categorized into different groups, such as based on feature space, label information, and so on. Heterogeneous transfer learning, for example, refers to the situation where source and target feature spaces are different in some respect.

### SUMMARY

Transfer learning can be useful in a number of different use cases. For example, in inter-Radio Access Technology (RAT)-type of use cases, there exists a heterogeneous ecosystem, where the source domains can execute different RATs with different feature spaces. This heterogeneity makes it difficult to transfer machine learning models in between source and target domains as the features and the number of features are not same. Even though not identical, source domains typically have at least some features in common with or similar to the target domain. Where the features between source and target domains have some similarity, transfer learning may be appropriate. But because the features may not be identical, it is important to fill in the missing attributes in the target domain by generating them while maintaining the dependency that exists between features in the target and source domains. It is also important for the target domain to be able to utilize a plurality of models from multiple source domains, instead of only a single source domain as in existing solutions.

One of the biggest challenges in this type of learning is when the source and target data features do not explicitly match, which means that the data attributes/features and also the data distribution are not the same. One approach considered here is to use generative models. Existing solutions do not employ generative models, especially models such as Generative Adversarial Network (GAN) type models and Variational Autoencoder (VAE) type models. Generative models (as used in embodiments herein) can increase robustness of machine learning models and are able to be executed regardless of the availability of labels. Accordingly, solutions employing generative models described herein are label-agnostic and can address cases which would typically be handled by unsupervised transfer learning in the literature. Conditional or Bayesian-based generative models may specifically be used in some embodiments.

Embodiments make use of generative modeling, such that multiple decoders are trained on multiple source domains, and then are sent to a given target domain. The target domain regenerates all features given the labels collected at the target domain in an iterative manner, e.g. arbitrarily choosing a source domain sequence. The useful features are then extracted and ensembled at the target domain, where a target model may be trained.

Embodiments provide for a number of advantages. The use of transfer learning reduces the amount of retraining that is needed, thereby reducing energy consumption, carbon footprint, and additional data collection processes. Applying transfer learning as taught herein is useful in cases where data is not available for a target domain, or where there are problems in the data collection pipe; and, by being able to train models with more samples, embodiments can increase the certainty in model predictions. Further, reusing existing knowledge (from source domains) is especially applicable when transferring a model in between similar types of systems based on different underlying technologies (e.g., 3rd Generation Partnership Project's (3GPP's) third generation (3G) standard, fourth generation (4G) standard, or fifth generation (5G) standard), since there exists some similarities in certain attributes (such as performance monitoring counters) despite the potentially significant differences in the technology. Embodiments use this similarity to help put together many different (potentially small) pieces of complementary information from multiple remote source nodes.

Embodiments are able to utilize multiple source domains instead of a single one, and can provide for seamless model transfer. For example, embodiments may provide a seamless handover of existing machine learning models that are trained on older technologies (e.g., 2G, 3G) to newer technologies (e.g., 4G, 5G, and beyond). Embodiments are task agnostic and source model agnostic, and hence do not necessitate that the source model task and the target model task are similar or the same. Embodiments provide for increased robustness in the model via synthetically generating realistic samples for training a larger network, thereby reducing the gaps in the model where it is not represented due to lack of data. In embodiments, by arbitrarily selecting source domain sequences and applying conditional feature generation, models may experience improved robustness.

Embodiments are source domain data agnostic. Since all attributes are first class citizens, the target domain aims to maximize the benefit from any attribute at the source domain. This removes the dependency on the labels (in contrast to semi-supervised, transductive, and inductive type learning). Embodiments also provide for a smaller network footprint (if decoder model is not completely symmetrical to encoder model, and rather smaller in size than encoder and the actual model itself) to send the decoder.

In embodiments, the sequence of selecting source domains can also be learned via a reinforcement learning (RL) agent for improvement.

According to a first aspect, a method for transfer learning from two or more source domains including a first source domain and a second source domain is provided. The method includes generating a first data by using a first decoder model with a first set of target features, wherein the first decoder model is based on the first source domain. The method further includes updating a final set of target features and final data based on the generated first data. The method further includes generating a second data by using a second decoder model with a second set of target features, wherein the second data that is generated is conditioned on the first set of target features and wherein the second decoder model is based on the second source domain. The method further includes updating the final set of target features and final data based on the generated second data. The method further includes training a target-domain model using the final data and the final set of target features.

In some embodiments, the method further includes obtaining a first list of features used by the first source domain. The method further includes obtaining a second list of features used by the second source domain. The first set of target features comprises the first list of features and the second set of target features comprises the second list of features. In some embodiments, obtaining a first list of features used by the first source domain comprises: sending to a first source domain a first feature list request; and receiving, in response to the first feature list request, a first list of features used by the first source domain. In some embodiments, obtaining a second list of features used by the second source domain comprises: sending to a second source domain a second feature list request; and receiving, in response to the second feature list request, a second list of features used by the second source domain.

In some embodiments, the method further includes obtaining the first decoder model. In some embodiments, obtaining the first decoder model comprises: requesting the first decoder model from the first source domain; and receiving the first decoder model. In some embodiments, the method further includes obtaining the second decoder model, wherein the second decoder model has been trained by the second source domain conditionally on the second set of target features. In some embodiments, the second decoder model has been trained by the second source domain conditionally on the subset of features common to the second set of target features and the first set of target features. In some embodiments, obtaining the second decoder model comprises: requesting the second decoder model from the second source domain; and receiving the second decoder model.

In some embodiments, the method further includes determining a decoder order sequence based on a number of features that are common among the two or more source domains, wherein the decoder order sequence indicates an order in which to generate the first data and the second data. In some embodiments, the method further includes determining a number of features that are common among the two or more source domains based on the first list of features and the second list of features; and determining a decoder order sequence based on the number of features that are common among the two or more source domains, wherein the decoder order sequence indicates an order in which to generate the first data and the second data. In some embodiments, one or more of the first decoder model and the second decoder model are one of a conditional Generative Adversarial Network (GAN) type model and a conditional Variational Autoencoder (VAE) type model.

In some embodiments, generating a first data by using the first decoder model with the first set of target features comprises filtering data generated by the first decoder model based on a similarity between source and target features; and wherein generating a second data by using the second decoder model with the second set of target features comprises filtering data generated by the second decoder model based on the similarity between source and target features. In some embodiments, similarity between source and target features is determined based on one or more distance measures. In some embodiments, the one or more distance measures are selected from the group consisting of a cosine similarity measure, a K-L divergence measure, a Euclidean measure, a Wasserstein measure, and a dot-product measure.

In some embodiments, the method further includes sending to a third source domain a third feature list request. The method further includes receiving, in response to the third feature list request, a third list of features used by the third source domain. The method further includes requesting a third decoder model with the third set of target features from the third source domain, wherein the third set of target features comprises the third list of features. The method further includes receiving the third decoder model, wherein the third decoder model has been trained by the third source domain conditionally on the subset of features common to the third set of target features and both the first and second sets of target features. The method further includes generating a third data by using the third decoder model with the third set of target features. The method further includes updating the final set of target features and final data based on the generated third data.

In some embodiments, a computer-implemented method of enabling transfer learning from two or more source domains according to any one of the preceding embodiments.

According to a second aspect, a target node is provided. The target node comprises processing circuitry and a memory containing instructions executable by the processing circuitry. The processing circuitry is operable to generate a first data by using a first decoder model with a first set of target features, wherein the first decoder model is based on the first source domain. The processing circuitry is further operable to update a final set of target features and final data based on the generated first data. The processing circuitry is further operable to generate a second data by using a second decoder model with a second set of target features, wherein the second data that is generated is conditioned on the first set of target features and wherein the second decoder model is based on the second source domain. The processing circuitry is further operable to update the final set of target features and final data based on the generated second data. The processing circuitry is further operable to train a target-domain model using the final data and the final set of target features.

According to a third aspect, a computer program is provided comprising instructions which when executed by processing circuitry causes the processing circuitry to perform the method of any embodiment of the first aspect.

According to a fourth aspect, a carrier containing the computer program of the third aspect is provided, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a machine learning system according to an embodiment.

FIG. 2 illustrates a machine learning system according to an embodiment.

FIG. 3 is a message flow diagram according to an embodiment.

FIG. 4 is a flow chart according to an embodiment.

FIG. 5 is a block diagram of an apparatus according to an embodiment.

FIG. 6 is a block diagram of an apparatus according to an embodiment.

### DETAILED DESCRIPTION

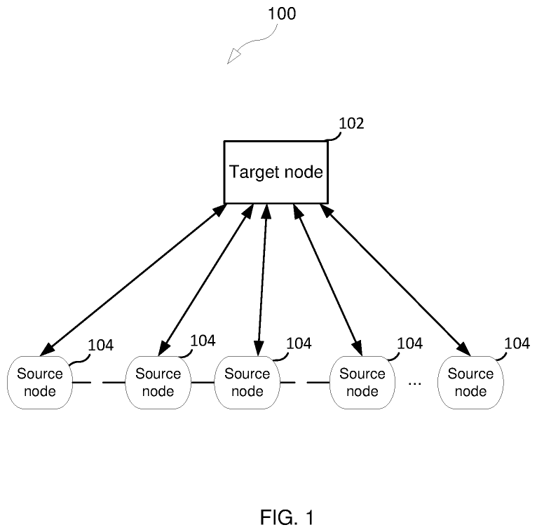

FIG. 1 illustrates a system 100 of machine learning according to an embodiment. As shown, a target node or computing device 102 is in communication with one or more source nodes or computing devices 104. Optionally, source nodes or computing devices 104 may be in communication with each other utilizing any of a variety of network topologies and/or network communication systems. For example, target nodes 102 or source nodes 104 include user computing devices such as a smart phone, tablet, laptop, personal computer, and so on, and may also be communicatively coupled through a common network such as the Internet (e.g., via WiFi) or a communications network (e.g., Long Term Evolution (LTE) or 5G). Target nodes 102 or source nodes 104 may also include computing devices such as servers, base stations, mainframes, and cloud computing resources. While a target node or computing device 102 is shown, the functionality of target node 102 may be distributed across multiple nodes, and may be shared between one or more of source nodes 104. Additionally, while a single target node 102 is shown, system 100 may include multiple target nodes 102 each interacting with the source nodes 104.

Embodiments utilize multiple source domains in an iterative manner, meaning that knowledge learned from one source domain is complemented with the other source domains until all knowledge is recovered. The iteration in the steps may also be applied in an arbitrary manner, in order to smooth out the effect sequence choice. In embodiments, different sequences for generating data are carried out in parallel, with their results assembled together by concatenation.

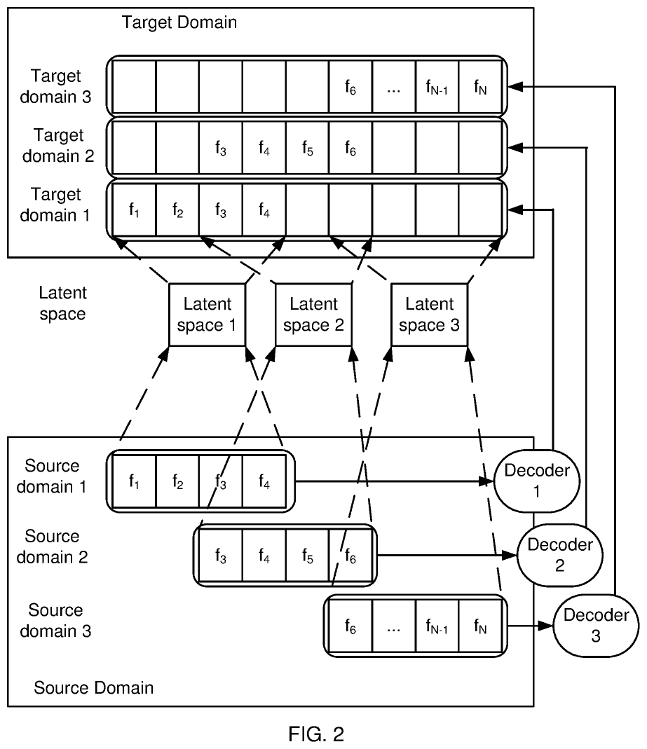

FIG. 2 illustrates an exemplary system. The target domain comprises three different target domains 1, 2, and 3. The source domain also comprises three different source domains 1, 2, and 3. This is for illustrative purposes, and in general, there may be fewer source and target domains, or there may be more, and the number of source and target domains may differ from each other or be the same. As shown, the source and target domains share a feature set including features f₁ through f_{N}; where a subset of these features is applicable to source/target domain 1 (f₁ through f₄), source/target domain 2 (f₃ through f₆), and source/target domain 3 (f₆ through f_{N}). There is a latent space which maps the features of the source domain onto the target domain. Additionally, three decoders 1, 2, and 3 are shown, which act on the corresponding source domain to produce a target domain output.

In this discussion, it is assumed that a model needs to be generated using the N features f₁ through f_{N}. In general, the value of N may vary, as can the selection of specific features needed to generate a model.

As shown in FIG. 2, the data synthesis process uses different decoders (decoders 1, 2 and 3) that are each independent processes, and the data generated in these independent processes have a consistent relationship among the generated attributes. However, the relationship to other attributes that are generated with the decoders does not necessarily hold the correlation. That is, decoder 1 has a consistent relationship with respect to features f₁ through f₄, but not necessarily the remaining features f₅ through f_{N}, among the data generated by each decoder. Similarly, the same holds for decoder 2 (consistent with respect to f₃ through f₆) and decoder 3 (consistent with respect to f₆ through f_{N}). Accordingly, in some embodiments, the data generated from multiple decoders need to be merged while keeping the correlation in between the attributes. One way to tackle this is to find out the most similar synthetic dataset with the common features, though in practice this may be infeasible. First, there may not be many samples that are similar to the generated data samples; and, second, the method to give a decision whether or not two samples are more similar than others is constrained by the amount of generated data. Hence, embodiments provide a synthetic data generation process that is conditioned on the previously generated data samples rather than a simultaneously independent data generation process. The synthetic data generation process may be considered a “just-in-time data generation” as a service to generate missing features conditioned on the features with an existing dataset that is updated at each iteration to include the previously generated data. That is, in embodiments, conditionally generating data based on previously generated data samples includes conditioning based on features of the cumulatively previously generated data that are in common with a new source node and for which data samples for those common features are available at the new source node.

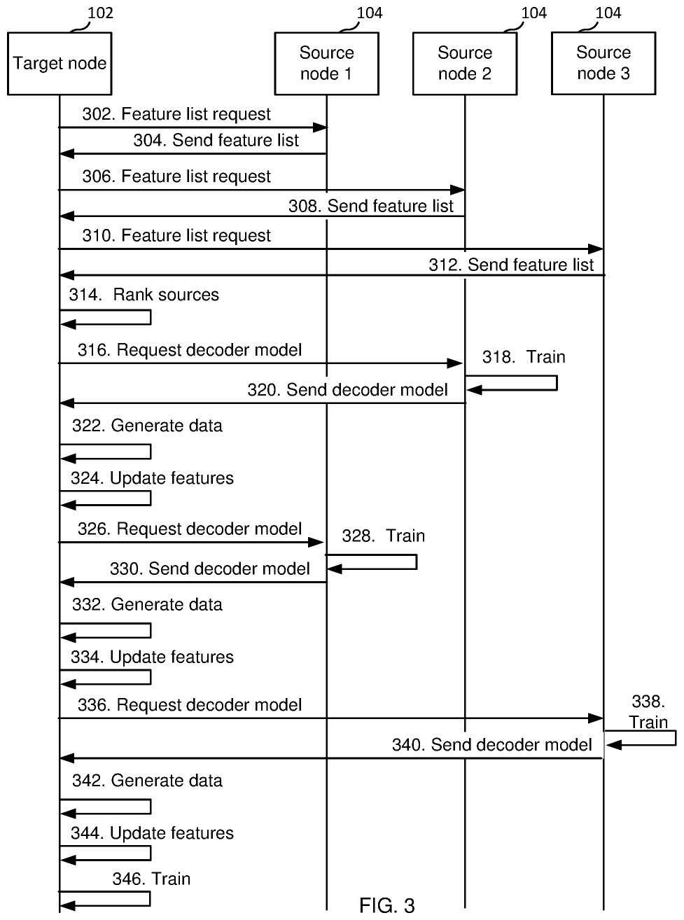

FIG. 3 illustrates a message flow diagram according to an embodiment.

As shown, target node 102 communicates with source nodes 104, and in particular three source nodes 1, 2, and 3.

The target node 102 may send a request to each of the source nodes 104 for a feature list (at 302, 306, and 310), and receive the respective feature list from the corresponding source node 104 (at 304, 308, and 312). By using the feature list information, the target node 102 may rank the source nodes 104 to determine a decoder order sequence that indicates the order in which data is to be generated. For example, the target node 102 may order rank the source nodes 104 based on the number of features common between the target node 102 and the corresponding source node 104. In embodiments, the source nodes 104 having a greater number of common features are ranked as coming prior to those having fewer common features. IN some embodiments, ranking of source nodes 104 may employ reinforcement learning techniques.

Following this, the target node 102 may proceed to generate data conditionally. Given the decoder order sequence, target node 102 requests the decoder model from the highest ranked decoder which in this case corresponds to source node 2 (at 316). Source node 2 trains the decoder (at 318). Because this is the first decoder to be trained, it does not need to be conditioned on previously generated data. After training, source node 2 sends the decoder to the target node 102 (at 320). Target node 102 uses the decoder it received to generate data (at 322) and to update a final feature set and data (at 324). The updating process comprises concatenation of the generated data with the previously generated data and may further include filtering out data of limited relevance.

The target node 102 continues this process of generating data until the final feature set and data include all features needed to train the target-domain model. As new data continues to be generated, it is done conditionally on the previously generated data. Continuing with this example, source node 1 is the next-highest ranked decoder. Target node 102 requests a decoder from source node 1 (at 326), source node 1 trains the decoder conditionally on the previously generated data (at 328), and sends the trained decoder back to the target node 102 (at 330). Target node 102 then uses the decoder to generate data (at 332) and to update the final feature set and data (at 334). As before, the updating process comprises concatenation of the generated data with the previously generated data and may further include filtering out data of limited relevance. Continuing with this example, source node 3 is the next-highest ranked decoder. Target node 102 requests a decoder from source node 3 (at 336), source node 3 trains the decoder conditionally on the previously generated data (at 338), and sends the trained decoder back to the target node 102 (at 340). Target node 102 then uses the decoder to generate data (at 342) and to update the final feature set and data (at 344). As before, the updating process comprises concatenation of the generated data with the previously generated data and may further include filtering out data of limited relevance.

At this point in the example, all the features needed to train the target-domain model have been generated, and the data generation process therefore stops. Accordingly, target node 102 may then train the target-domain model (at 346).

Embodiments can include one or more of (1) iterative data generation at the target domain; (2) determining similar features between source and target domains (e.g., taking into account slightly different applications, and where feature names are not obvious or unknown); and (3) training the model at the target domain with the generated and reordered dataset based on the problem formulation. These steps are further described below.

(1) Iterative Data Generation at the Target Domain

Embodiments train a generative model (such as a GAN type, VAE type, or autoencoder type model), and preferably a generative model that is conditional, at the source domain. These decoder may be labeled as “D”, e.g. decoders D1, D2, . . . , DN for some value of N.

Once trained, the source domain may send the decoder of the generative model to the target domain. In some embodiments, the decoder may be sent with the order of the feature/attribute names associated with the decoder.

Once the target domain received the decoder, it may generates a synthetic dataset conditioned on the previously generated synthetic dataset. If there is no previously generated synthetic dataset, such as because the current decoder is the first one being used, the decoder generates a synthetic dataset without being conditioned. This may also be interpreted as conditioning the generation on the null set. In some embodiments, generating the synthetic dataset comprises arbitrarily selecting the first latent variable, followed by a random walk in the latent space.

Taking the example of FIG. 2, source domains 1 and 2 have features f₃ and f₄ as common features. Taking decoder 1 from source domain 1 as the first decoder to generate data with, a synthetic dataset 1 is generated with features f₁, f₂, f₃, and f₄. Next, taking decoder 2 from source domain 2 as the next decoder to generate data with, decoder 2 generates synthetic samples that are conditioned on the data generated via decoder 1. For example, because f₃ and f₄ are common between source domains 1 and 2, the conditioning may be with respect to these common features f₃ and f₄. Decoder 2 may then generate, for example, f₅ and f₆ as conditioned on f₃ and f₄. This process is repeated, with each decoder successively generating data conditioned on the previously generated data. This is repeated until all data needed to generate all features are generated, and eventually, therefore, the inter-relation in between features is preserved.

Generated data samples will be dependent on the data generation sequence, that is, the order of decoders that are selected to generate data. In the above example, the order was to first use decoder 1, followed by decoder 2, and then finally decoder 3. Thus, in this example, there will be samples that are conditioned on decoder 1, bounded by the generated f₁, f₂, f₃, and f₄ span. In some embodiments, the data generation sequence may be chosen arbitrarily, may depend in part on the features of each decoder (e.g., the number of features that a decoder has in common with other decoders), or some combination of this. In some embodiments, after the data is generated on all sequences, the generated datasets are appended to construct the final large training data.

For example, a synthetic data matrix M may be initialized to be empty, and then subsequently appended to. For a given decoder sequence, the first decoder in the sequence may generate data without conditioning, the second decoder generates data conditioned on the previously generated data, and so on. The concatenation of all the data so generated may be added to the synthetic data matrix M. This process may be repeated, for different decoder sequences, spanning in some embodiments all permutations of decoder sequences. After each sequence generates data, the concatenated data is added to the synthetic data matrix M.

(2) Determining Similar Features Between Source and Target Domains

A given decoder may generate a lot more features than are relevant for a given target domain. Continuing with the example of FIG. 2, decoder 2 may generate (conditioned on f₃ and f₄) more data than f₅ and f₆, some of which might be irrelevant to the target domain. Therefore, it can be important in some embodiments to determine feature similarity. Such similarity might be used to filter in f₅ and f₆ and filter out the rest of the attributes that are not relevant to the target domain.

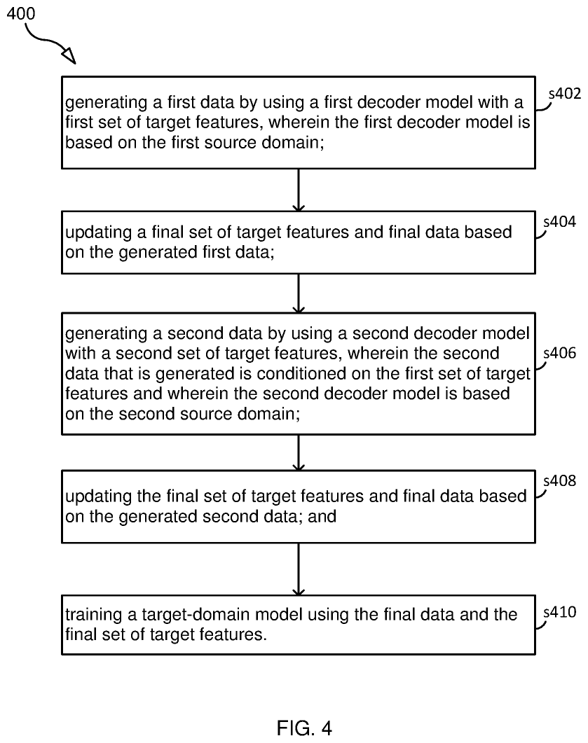

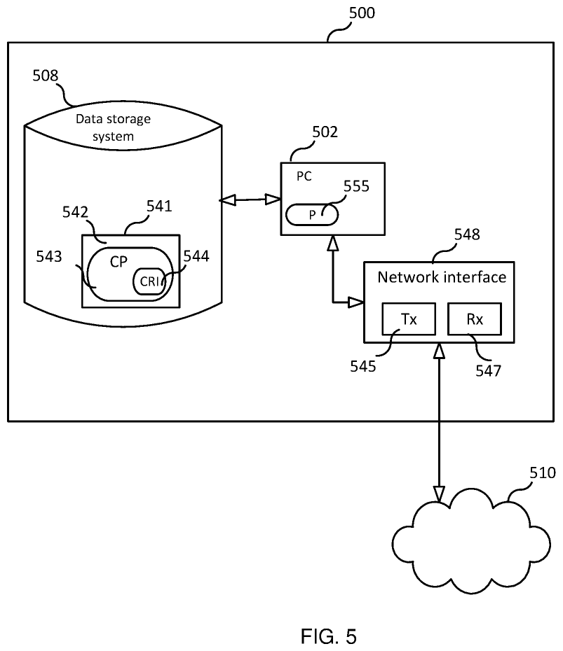

In cases where the feature names are different (or unknown) between the source and target domains, the content under the features (the data distribution) can be similar. As an example, consider two radio technology cases, where different feature names are used in 3G and 4G technology such as ‘4g_rssi_avg’ and ‘3g_mean_rtwp.’ These two features indicate fairly the same parameters, as demonstrated by FIG. 4 (showing 4g_rssi_avg) and FIG. 5 (showing 3g_mean_rtwp). Note that “rtwp” stands for Received Total Wideband Power and “rssi” stands for Received Signal Strength Indicator. As another example, again between 3G and 4G technology, ‘4g_volte_drop_pct’ and ‘3g_cs_speech_success_pct’ are the same type of measures in percentage to validate the performance of the voice services in 4G and 3G respectively. Other examples abound.

Therefore, when the data is generated at the target domain by a given decoder, the generated features are preferably normalized and filtered based on similarity. In embodiments, one procedure for filtering in the beneficial features and filtering out the other features is as follows. First, the generated data and the real data at the target domain are normalized. Although the real magnitude of the observed features may be different across domains (e.g., in between different frequencies or technologies), when the dataset is normalized, similar pattern can be observed. For all features f, of M, M_{f}=Normalize(M_{f}). Following normalization, the similarity of attributes on the two normalized datasets can be determined, resulting in a mapping between the real and synthetic dataset based on similarity. The data generated using a decoder from a source domain might generate samples that are not relevant at the target domain; selecting only the features that are relevant to the model at the target domain is useful in some embodiments. When a decoder is sent to a target domain from a source domain, the target domain should find out which features would likely benefit the model at the target domain. The generated samples represent the characteristics of the source domain dataset. Finding out the similar features at the source domain may be performed by extracting only the parts of the data that benefit the target domain via a data-driven manner.

Similarity may be based on one or more distance measures, such as a cosine similarity measure, a K-L divergence measure, a Euclidean measure, a Wasserstein measure, and a dot-product measure.

(3) Training the Model at the Target Domain with the Generated and Reordered Dataset Based on the Problem Formulation

Following the generation of data, and any filtering of that data that may be performed, the final supervised learning model may be trained with the desired input and target attributes (possibly by reordering the attributes) based on the use case at the target domain.

Use Cases

As discussed, transfer learning can be useful for use cases involving transfer of learning in between different technologies where there are at least one set of features (e.g., pm counters) that are common or similar in the two technology domains. One example use case can be given in the scope of radio networks which is related to a real time autonomous jammer detection framework. The real time autonomous jammer detection requires observing radio key performance indicators (KPIs) and ought to be configured for different technologies (e.g., 3G, 4G, 5G, and beyond) on different frequencies. Furthermore, the detection of jammer activation procedure involves over- or under-sampling of the dataset that is suitable to the target technology and/or frequency such that it maximizes the accuracy on the target.

The wireless networks are highly vulnerable to jamming attacks. Furthermore, to identify when is a jammer is active, an effective and low overhead, a real-time automated based jammer activation detection framework including machine learning (ML) and artificial intelligence (AI) models is necessary. Such jammer signal distortions or disruptions, on the radio networks, may be caused by a different type of conventional jammers. Their effects on 3G, 4G, and 5G network performance are not the same nor are the severity on different frequencies the same. Although the high-impact jammers can be determined from high RSSI, bad accessibility, or integrity KPIs such as Random-Access Channel (RACH) failure, even such successful detection requires specific studies and cannot provide fast enough solutions. Accordingly, GSM operators need a smart reasoning method driven by network-side operational data to determine the location and effects of the jammer in real-time by consolidating the position information of the base stations and intensity of the impact of the carriers around the jammer. Ideally, the jammer activation should be detected promptly, and the location of the jammer should be identified in a fast manner to minimize the downtime of the service.

The KPIs are slightly different for different network technologies and depending on the model set-up requires different training processes and procedures for the cells on different frequencies.

Although the input features of the jammer detection ML problem are more or less targeting to reflect the same performance indicator such as VoIP packet drop rate, RACH access failure, they are slightly different in part because characteristics of the technology differs (e.g., for 3G, 4G, 5G) and each network is deployed on different frequencies. More specifically, for the jammer activation indication an anomaly detection model can be developed based on observing the variation of an RSSI parameter. The RSSI parameter in a low-frequency (e.g. LTE) cell might be between −90 dBm and −120 dBm; on a high-frequency cell, the RSSI values might be in a different interval over time. Thus, there is a need to train the same/slightly similar jammer activation detection model for each technology. Using transfer learning, as disclosed in embodiments herein, can be advantageous for this and other use cases.

FIG. 4 illustrates a flow chart according to an embodiment. Process 400 is a method for transfer learning from two or more source domains including a first source domain and a second source domain. Process 400 may be performed by a target node computing device 102. Process 400 may begin with step s402.

Step s402 comprises generating a first data by using a first decoder model with a first set of target features, wherein the first decoder model is based on the first source domain.

Step s404 comprises updating a final set of target features and final data based on the generated first data.

Step s406 comprises generating a second data by using a second decoder model with a second set of target features, wherein the second data that is generated is conditioned on the first set of target features and wherein the second decoder model is based on the second source domain.

Step s408 comprises updating the final set of target features and final data based on the generated second data.

Step s410 comprises training a target-domain model using the final data and the final set of target features.

In some embodiments, the method further includes obtaining a first list of features used by the first source domain; and obtaining a second list of features used by the second source domain. The first set of target features comprises the first list of features and the second set of target features comprises the second list of features. In some embodiments, obtaining a first list of features used by the first source domain comprises sending to a first source domain a first feature list request; and receiving, in response to the first feature list request, a first list of features used by the first source domain. In some embodiments, obtaining a second list of features used by the second source domain comprises sending to a second source domain a second feature list request; and receiving, in response to the second feature list request, a second list of features used by the second source domain.

In some embodiments, the method may further include obtaining the first decoder model. In some embodiments, obtaining the first decoder model comprises requesting the first decoder model from the first source domain; and receiving the first decoder model. In some embodiments, the method further includes obtaining the second decoder model, wherein the second decoder model has been trained by the second source domain conditionally on the second set of target features. In some embodiments, the second decoder model has been trained by the second source domain conditionally on the subset of features common to the second set of target features and the first set of target features. In some embodiments, obtaining the second decoder model comprises requesting the second decoder model from the second source domain; and receiving the second decoder model.

In some embodiments, the method further includes determining a decoder order sequence based on a number of features that are common among the two or more source domains. The decoder order sequence indicates an order in which to generate the first data and the second data. In some embodiments, the method further includes determining a number of features that are common among the two or more source domains based on the first list of features and the second list of features; and determining a decoder order sequence based on the number of features that are common among the two or more source domains, wherein the decoder order sequence indicates an order in which to generate the first data and the second data. In some embodiments, one or more of the first decoder model and the second decoder model are one of a conditional Generative Adversarial Network (GAN) type model and a conditional Variational Autoencoder (VAE) type model.

In some embodiments, generating a first data by using the first decoder model with the first set of target features comprises filtering data generated by the first decoder model based on a similarity between source and target features and generating a second data by using the second decoder model with the second set of target features comprises filtering data generated by the second decoder model based on the similarity between source and target features. In some embodiments, similarity between source and target features is determined based on one or more distance measures; and in some embodiments the one or more distance measures are selected from the group consisting of a cosine similarity measure, a K-L divergence measure, a Euclidean measure, a Wasserstein measure, and a dot-product measure.

In some embodiments, the method further includes sending to a third source domain a third feature list request; receiving, in response to the third feature list request, a third list of features used by the third source domain; requesting a third decoder model with the third set of target features from the third source domain, wherein the third set of target features comprises the third list of features; receiving the third decoder model, wherein the third decoder model has been trained by the third source domain conditionally on the subset of features common to the third set of target features and both the first and second sets of target features; generating a third data by using the third decoder model with the third set of target features; and updating the final set of target features and final data based on the generated third data.

FIG. 5 is a block diagram of an apparatus 500 (e.g., a target node 102), according to some embodiments. As shown in FIG. 5, the apparatus may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like); a network interface 548 comprising a transmitter (Tx) 545 and a receiver (Rx) 547 for enabling the apparatus to transmit data to and receive data from other nodes connected to a network 510 (e.g., an Internet Protocol (IP) network) to which network interface 548 is connected; and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes the apparatus to perform steps described herein (e.g., steps described herein with reference to the flow charts). In other embodiments, the apparatus may be configured to perform steps described herein without the need for code. That is, for example, PC 502 may consist merely of one or more ASICs. Hence, the features of the embodiments described herein may be implemented in hardware and/or software.

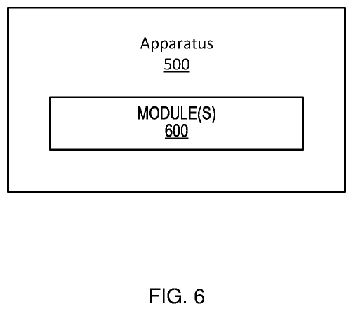

FIG. 6 is a schematic block diagram of the apparatus 500 according to some other embodiments. The apparatus 500 includes one or more modules 600, each of which is implemented in software. The module(s) 600 provide the functionality of apparatus 500 described herein (e.g., the steps herein, e.g., with respect to FIG. 3-4).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for transfer learning from two or more source domains including a first source domain and a second source domain, the method comprising:
generating a first data by using a first decoder model with a first set of target features, wherein the first decoder model is based on the first source domain;
updating a final set of target features and final data based on the generated first data;
generating a second data by using a second decoder model with a second set of target features, wherein the second data that is generated is conditioned on the first set of target features and wherein the second decoder model is based on the second source domain;
updating the final set of target features and final data based on the generated second data; and
training a target-domain model using the final data and the final set of target features.

2.-16. (canceled)

17. A computer-implemented method of enabling transfer learning from two or more source domains according to claim 1.

18. A target node, the target node comprising processing circuitry and a memory containing instructions executable by the processing circuitry, whereby the processing circuitry is operable to:
generate a first data by using a first decoder model with a first set of target features, wherein the first decoder model is based on the first source domain;
update a final set of target features and final data based on the generated first data;
generate a second data by using a second decoder model with a second set of target features, wherein the second data that is generated is conditioned on the first set of target features and wherein the second decoder model is based on the second source domain;
update the final set of target features and final data based on the generated second data; and
train a target-domain model using the final data and the final set of target features.

19. The target node of claim 18, whereby the processing circuitry is further operable to:
obtaining a first list of features used by the first source domain; and
obtaining a second list of features used by the second source domain,
wherein the first set of target features comprises the first list of features and the second set of target features comprises the second list of features.

20. The target node of claim 19, wherein obtaining a first list of features used by the first source domain comprises:
sending to a first source domain a first feature list request; and
receiving, in response to the first feature list request, a first list of features used by the first source domain.

21. The target node of claim 19, wherein obtaining a second list of features used by the second source domain comprises:
sending to a second source domain a second feature list request; and
receiving, in response to the second feature list request, a second list of features used by the second source domain.

22. The target node of claim 18, further comprising:
obtaining the first decoder model.

23. The target node of claim 22, wherein obtaining the first decoder model comprises:
requesting the first decoder model from the first source domain; and
receiving the first decoder model.

24. The target node of claim 18, further comprising:
obtaining the second decoder model, wherein the second decoder model has been trained by the second source domain conditionally on the second set of target features.

25. The target node of claim 24, wherein the second decoder model has been trained by the second source domain conditionally on the subset of features common to the second set of target features and the first set of target features.

26. The target node of claim 24, wherein obtaining the second decoder model comprises:
requesting the second decoder model from the second source domain; and
receiving the second decoder model.

27. The target node of claim 18, further comprising determining a decoder order sequence based on a number of features that are common among the two or more source domains, wherein the decoder order sequence indicates an order in which to generate the first data and the second data.

28. The target node of claim 19, further comprising:
determining a number of features that are common among the two or more source domains based on the first list of features and the second list of features; and
determining a decoder order sequence based on the number of features that are common among the two or more source domains, wherein the decoder order sequence indicates an order in which to generate the first data and the second data.

29. The target node of claim 18, wherein one or more of the first decoder model and the second decoder model are one of a conditional Generative Adversarial Network (GAN) type model and a conditional Variational Autoencoder (VAE) type model.

30. The target node of claim 18, wherein generating a first data by using the first decoder model with the first set of target features comprises filtering data generated by the first decoder model based on a similarity between source and target features; and wherein generating a second data by using the second decoder model with the second set of target features comprises filtering data generated by the second decoder model based on the similarity between source and target features.

31. The target node of claim 30, wherein similarity between source and target features is determined based on one or more distance measures.

32. The target node of claim 31, wherein the one or more distance measures are selected from the group consisting of a cosine similarity measure, a K-L divergence measure, a Euclidean measure, a Wasserstein measure, and a dot-product measure.

33. The target node of claim 18, further comprising:
sending to a third source domain a third feature list request;
receiving, in response to the third feature list request, a third list of features used by the third source domain;
requesting a third decoder model with the third set of target features from the third source domain, wherein the third set of target features comprises the third list of features;
receiving the third decoder model, wherein the third decoder model has been trained by the third source domain conditionally on the subset of features common to the third set of target features and both the first and second sets of target features;
generating a third data by using the third decoder model with the third set of target features; and
updating the final set of target features and final data based on the generated third data.

34.-35. (canceled)
